(19) United States
(12) Patent Application Publication
(10) Pub. No.: US 2008/0056649 A1
(43) Pub. Date: Mar. 6, 2008

(54) Dry inserts and optical waveguide assemblies and cables using the same

(76) Inventors: Randall E. Fulbright, Vale, NC (US); Douglas S. Hedrick, Connelly Springs, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/513,940

(22) Filed: Aug. 31, 2006

(51) Int. Cl. G02B 6/44

(52) U.S. Cl. 385/100

(57) ABSTRACT

A dry insert is disclosed that is suitable for use in an optical waveguide assembly. The dry insert includes a compressible layer and at least one reinforcing element that are attached together. The compressible layer having a modulus of elasticity in a longitudinal direction of the dry insert and the reinforcing element having a modulus of elasticity in the longitudinal direction, where the modulus of elasticity of the at least one reinforcing element is greater than the modulus of elasticity of the compressible layer for inhibiting a longitudinal stretching of the dry insert under a tensile load. In one embodiment, the dry insert has a strain of about 1 percent or less along the longitudinal direction when a tensile load of about 10 Newtons is applied. Various modifications and options for the dry insert are possible.

### FIELD OF THE INVENTION

The present invention relates generally to dry inserts for the dry packaging of one or more optical waveguides such as optical fibers in fiber optic cables and/or assemblies. More particularly, the present invention concerns dry inserts that inhibit longitudinal stretching thereof along with their use in fiber optic cables and/or assemblies.

### BACKGROUND OF THE INVENTION

Fiber optic cables and/or assemblies include optical waveguides such as optical fibers that transmit optical signals, for example, voice, video, and/or data information. One type of fiber optic assembly includes one or more optical waveguides disposed within a tube or a cable jacket, thereby forming an optical waveguide assembly. Generally speaking, the tube protects the optical waveguide; however, the optical waveguide must be further protected within the tube for preserving optical performance in outside plant applications. For instance, the optical waveguide should have some relative movement between the optical waveguide and the tube to accommodate bending. Likewise, the optical waveguide should be adequately coupled with the tube, thereby inhibiting the optical waveguide from being displaced within the tube when, for example, pulling forces are applied to install the fiber optic cable. Additionally, the optical waveguide assembly should inhibit the migration of water therein and allow for operation over a wide range of temperatures without undue optical performance degradation.

Conventional optical waveguide assemblies meet these requirements by filling the tube with a thixotropic material such as grease or gel. Thixotropic materials generally allow for adequate movement between the optical waveguide and the tube while providing adequate cushioning and coupling of the optical waveguide. Furthermore, thixotropic materials are effective for blocking the migration of water within the tube. However, the thixotropic materials have disadvantages. For instance, thixotropic materials must be cleaned from the optical waveguide before connectorization of the same. Cleaning the thixotropic material from the optical waveguide is a messy and time-consuming process for the craft. Moreover, the viscosity of thixotropic materials is generally temperature dependent. Consequently, the thixotropic materials can drip from an end of the tube at relatively high temperatures and the thixotropic materials may cause optical attenuation at relatively low temperatures.

Several dry cable designs have emerged that-have attempted to eliminate the thixotropic materials from the tube containing the optical fiber, but most of the designs have not met all of the requirements for providing a dry solution (i.e., eliminating the thixotropic material) for outside plant applications. Commercially successful dry packaging solutions for optical waveguides are disclosed in U.S. Pat. No. 6,970,629, the disclosure of which is incorporated herein by reference in its entirety. In one embodiment, U.S. Pat. No. 6,970,629 discloses a tube assembly having a dry insert that includes a compressible layer and a water-swellable layer generally disposed about at least one optical waveguide such as a stack of optical fiber ribbons.

Manufacturing different types of fiber optic assemblies or cables can require different manufacturing equipment, techniques, and/or processes. By way of example, different manufacturing equipment and/or techniques are employed depending on the type of stranding applied to a stack of optical fiber ribbons. For instance, when a ribbon stack is S-Z stranded (i.e., periodically reversing the stranding direction of the ribbon stack from clockwise to counter-clockwise) a back tension is created on the structure being stranded. In other words, the switchback of the S-Z stranding causes a back tension for the optical fiber ribbons being S-Z stranded and/or components contacting the ribbons being S-Z stranded. Consequently, components contacting a ribbon stack being S-Z stranded may be subject to tensile forces in the longitudinal direction due to S-Z stranding of the ribbon stack. Additionally, other manufacturing techniques may also contribute to the back tension experienced during manufacturing. The present invention addresses the problems associated with tension being applied to components and/or assemblies during the manufacturing process.

### SUMMARY OF THE INVENTION

The present invention is directed to dry inserts suitable for use in optical waveguide assemblies such as a fiber optic cable. In one aspect of the invention, a dry insert includes a compressible layer and at least one reinforcing element that are attached together. The compressible layer has a modulus of elasticity in a longitudinal direction and the reinforcing element having a modulus of elasticity in a longitudinal direction of the dry insert, wherein the modulus of elasticity of the at least one reinforcing element is greater than the modulus of elasticity of the compressible layer, thereby inhibiting a longitudinal stretching of the dry insert under a tensile load. Additionally, the dry insert has a strain of about 1 percent or less along the longitudinal direction when a tensile load of about 10 Newtons is applied in the same direction.

In another aspect, the present invention is directed to a dry insert suitable for use in an optical waveguide assembly, the dry insert including a compressible layer and at least one reinforcing layer that are attached together. The compressible layer has a modulus of elasticity in a longitudinal direction of the dry insert and the reinforcing element has a modulus of elasticity in the longitudinal direction of the dry insert, wherein the modulus of elasticity of the at least one reinforcing element at least about 2 times greater than the modulus of elasticity of the compressible layer, thereby inhibiting a longitudinal stretching of the dry insert under a tensile load.

A further aspect of the present invention is directed to an optical waveguide assembly including at least one optical waveguide, at least one dry insert, and a tube. The at least one optical waveguide and the at least one dry insert form a core and the tube is disposed about the core. The dry insert includes a compressible layer and at least one reinforcing element that are attached together. The compressible layer has a modulus of elasticity in a longitudinal direction of the at least one dry insert and the reinforcing element has a modulus of elasticity in the longitudinal direction of the at least one dry insert, wherein the modulus of elasticity of the at least one reinforcing element is greater than the modulus of elasticity of the compressible layer, thereby inhibiting a longitudinal stretching of the dry insert under a tensile load.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate the various exemplary embodiments of the invention, and together with the description serve to explain the principals and operations of the invention.

### BRIEF DESCRIPTION OF THE DRAWINGS

FIG. 1 is a cross-sectional view of an explanatory optical waveguide assembly according to the present invention;

FIG. 2 is a perspective view of the dry insert of the optical waveguide assembly of FIG. 1;

FIG. 3 is a perspective view of an another dry insert for use with various optical waveguide assemblies and/or cables according to the present invention;

FIG. 4 is a perspective view of another dry insert for use with various optical waveguide assemblies and/or cables according to the present invention;

FIG. 5 is a perspective view of yet another alternate dry insert for use with various optical waveguide assemblies and/or cable according to the present invention;

FIG. 6 is a cross-sectional view of another explanatory optical waveguide assembly according to the present invention;

FIG. 7 is a cross-sectional view of an explanatory optical fiber cable using the optical waveguide assembly of FIG. 1 according to the present invention;

FIG. 8 is a cross-sectional view of another explanatory optical waveguide assembly configured as fiber optic cable according to the present invention; and

FIG. 9 is a schematic representation of an explanatory manufacturing line for making optical waveguide assemblies and/or fiber optic cables according to the present invention.

### DETAILED DESCRIPTION OF THE PREFERRED EMBODIMENTS

Reference will now be made in detail to the present preferred embodiments of the invention, examples of which are illustrated in the accompanying drawings. Whenever possible, the same reference numerals will be used throughout the drawings to refer to the same or like parts. The exemplary embodiments of the invention are useful for dry packaging of optical waveguide assemblies of various designs. Thus, it should be understood that the dry inserts and optical waveguide assemblies disclosed herein are merely examples, each incorporating certain benefits of the present invention.

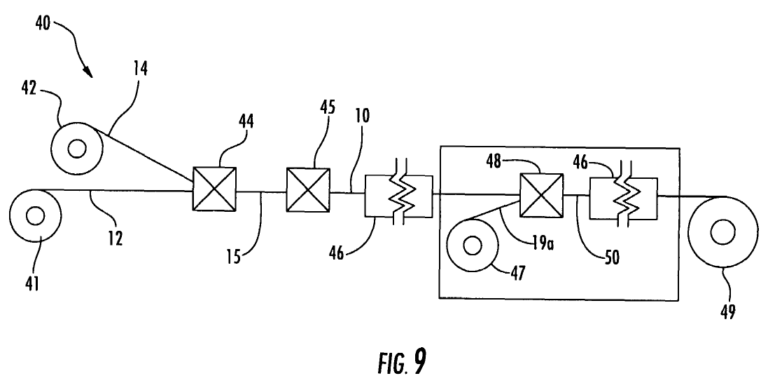

With reference now to FIG. 1, there is illustrated an optical waveguide assembly 10 including at least one optical waveguide 12, at least one dry insert 14, and a tube 18. As depicted, the optical waveguides 12 are a portion of a fiber optic ribbon 13 and a plurality of fiber optic ribbons 13 form a stack of ribbons (not numbered) that are stranded. As shown, dry insert 14 is generally disposed about the optical waveguides 12 and forms a core 15 disposed within tube 18. Dry insert 14 performs the functions of cushioning the optical waveguides 12, coupling the optical waveguides with tube 18, inhibiting the migration of water within the tube, and accommodates bending of the assembly. Optical waveguide assembly 10 is advantageous because the optical waveguides are easily accessed without leaving a residue or film that requires cleaning before connectorization, thereby saving the craft time and expense. Moreover, unlike conventional thixotropic materials, dry insert 14 does not change viscosity with temperature variations or have propensity to drip from an end of the tube at high temperatures. Optical waveguide assembly 10 can include other optional components such as polyester binder thread 17 for securing dry insert 14 about optical waveguide 12. Additionally, optical waveguide assembly 10 can be a portion of a cable as shown in FIG. 7. In other embodiments, core 15 can have other arrangements and/or be used in other configurations such as the tubeless cable shown in FIG. 8.

FIG. 2 illustrates a perspective view of dry insert 14 used in optical waveguide assembly 10. Dry insert 14 is formed from one or more elongate materials and is capable of being paid off from a reel for a continuous application during the manufacture of optical waveguide assembly 10. As shown in FIG. 2, dry insert 14 includes a compressible layer 14a and at least one reinforcing element 14b that are attached together. Compressible layer 14a of dry insert 14, among other things, cushions and couples ribbons 13 (or other optical waveguides), thereby preserving the optical performance of the same during operation. In other words, compressible layer allows movement of the optical waveguides while providing the required level of coupling between the ribbon stack and tube 18. However, because compressible layer 14a has a resilient nature (i.e., compressible) for cushioning it also is relatively easy to stretch longitudinally. Stretching of the dry insert during the manufacturing operation can have undesirable consequences. For instance, stretching of dry insert may lead to breaks in the dry insert which at a minimum requires stopping the manufacturing line and may lead to scrapping the cable. Even if the dry insert does not break, after the removal of tension from the dry insert it may contract (after being stretched) and disrupt the excess ribbon length (ERL) within the cable. Simply stated, preserving optical performance and/or controlling ERL is necessary for manufacturing assemblies and/or cables that operate properly.

Dry insert 14 of the present invention also includes reinforcing elements 14b for withstanding the tensile forces experienced during manufacturing, thereby inhibiting the stretching of dry insert 14. Reinforcing elements 14b are advantageous since they inhibit the propensity of dry insert 14 to stretch under typical manufacturing tensions. Reinforcing element 14b (or the plurality of reinforcing elements 14b collectively, if more than one is present) has a modulus of elasticity greater than that of the compressible layer 14a in longitudinal direction D. Therefore, the at least one reinforcing element 14b inhibits stretching of dry insert 14 by carrying the majority of the applied tensile load to dry insert 14 during manufacture and after deployment. Consequently, compressible layer 14a may be chosen from suitable materials that cushion and couple the optical waveguides while lessening the concern about the tensile characteristics of the same.

As shown in FIG. 1, compressible layer 14a generally contacts portions of the ribbon stack (or optical waveguides FIG. 6) and the material selected should be suitable for contact; but, other optional components could inhibit or reduce contact therebetween. By way of example, compressible layer 14a made of a foam tape, preferably, an open cell foam tape; however, any suitable compressible material can be used such as a closed cell foam tape, felt-like material, or the like. Compressible layer 14a may be compressed during assembly so that it provides a predetermined normal force that inhibits ribbons 13 from being easily displaced longitudinally along tube 18. Generally speaking, compression of dry insert 14 is a localized compression such as the compression experienced by dry insert 14 near the corner optical waveguides of the ribbon stack and is in the range of about 0% to about 50% or more. Dry insert 14 preferably has an uncompressed height h of about 5 mm or less for minimizing the tube diameter and/or cable diameter; however, any suitable height h can be used for dry insert 14. Additionally, height h of dry insert 14 need not be constant across the width, but can vary, thereby conforming to the cross-sectional shape of the optical waveguides and providing improved cushioning to improve optical performance.

One suitable material for compressible layer 14a is an open cell polyurethane (PU) foam tape. The PU foam tape may either be an ether-based PU or an ester-based PU, but other suitable foam tape compressible layers can be used such as a polyethylene foam, a polypropylene foam, or EVA foam. However, preferred embodiments use an ether-based foam tape since it performs better than an ester-based PU foam when subject to moisture. In other words, the ester-based PU foam can break down with moisture, whereas the ether-based PU foam is generally more robust with respect to moisture. Additionally, the compressible layer 14a has a predetermined density generally in the range of about 1 lb/ft³ to about 3 lb/ft³.

As illustrated in FIG. 2, reinforcing element 14b comprises at least one tensile yarn extending along dry insert 14 in a longitudinal direction D. Reinforcing element 14b may be made of any suitable material such as fiberglass, aramid, metal, woven or non-woven tape, or a plastic and have any suitable shape such as round, rectangular, or the like. As shown in FIG. 2, reinforcing element 14b is depicted within compressible layer 14a. Of course, reinforcing elements 14b may have other suitable locations within dry insert 14 as discussed herein. By way of example, FIG. 3 depicts a plurality of reinforcing elements 14b at least partially disposed within compressible layer 14a, more specifically, reinforcing element 14b are located along an edge portion of compressible layer 14a.

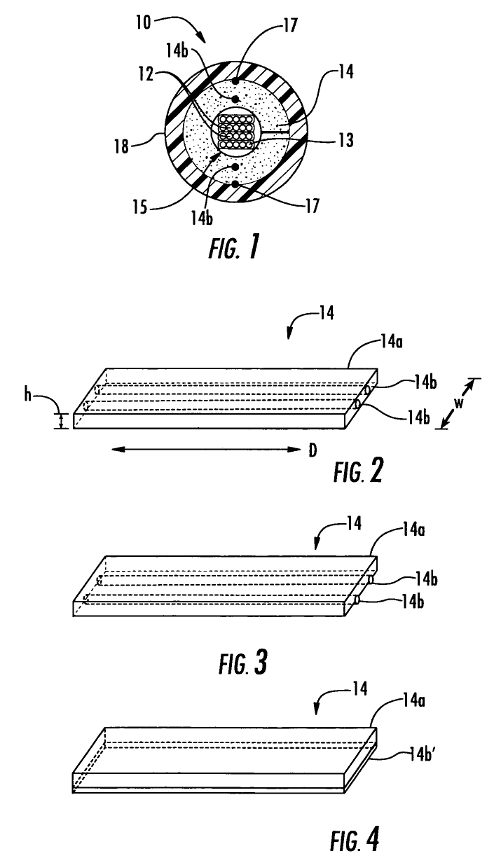

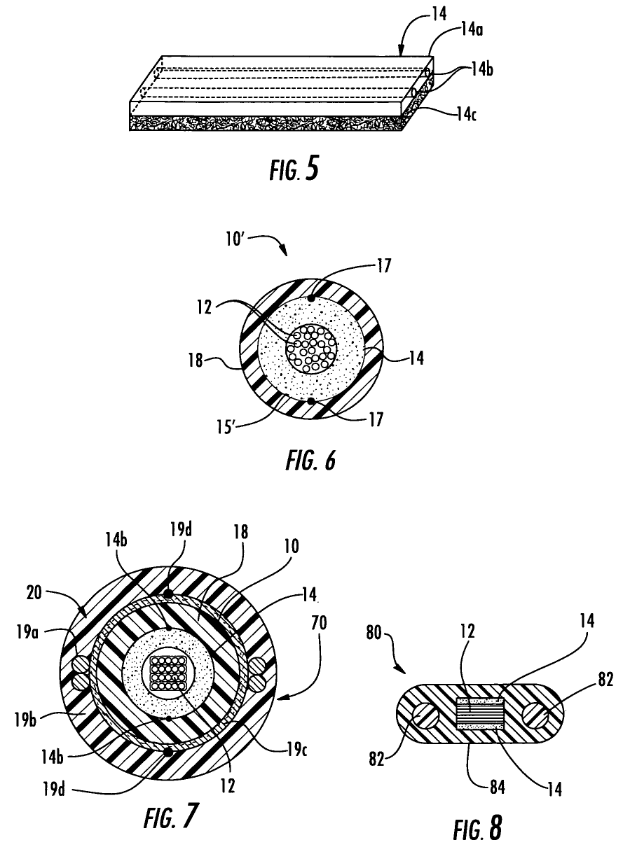

Reinforcing elements of dry insert 14 can have other shapes and/or use other suitable materials. As shown in FIG. 4, reinforcing element 14b′ is a tape backing layer having about the same width as compressible layer 14a. Consequently, there is a relatively large amount of surface area for attaching reinforcing element 14b′ with compressible layer 14a. For instance, reinforcing element 14b′ is formed from a polyester backing layer that is attached to compressible layer 14a using a glue, adhesive, or the like. Of course, other suitable materials may be used instead of polyester for the backing layer such as nylon or like materials. In still other variations, reinforcing element 14b′ may include an optional water-swellable component for blocking the migration of water within the cable such as super absorbent particles attached to reinforcing element 14b′. Other embodiments of dry insert can include a separate component having a water-swellable characteristic.

By way of example, FIG. 5 depicts dry insert 14 having a compressible layer 14a and at least one reinforcing element 14b similar to the dry insert of FIG. 2. However, dry insert 14 of FIG. 5 further includes a water-swellable component 14c. Water-swellable component 14c is formed as a longitudinal tape, such as a spunbonded non-woven polyester tape impregnated with a super-absorbent material such as polyacrylate or polyacrylimide for blocking the migration of water. Of course, other materials and other configurations could be employed as well. For example, water-swellable component 14c can be formed from a water swellable yarns instead of a longitudinal tape. Additionally, dry inserts can include other characteristics for providing additional functions such as flame retardance, smoke suppression, or the like.

Both compressible layer 14a, and optional water-swellable component 14c, may be substantially continuous along the longitudinal direction of the dry insert as shown. However, compressible layer or water-swellable component may also be discontinuous as desired for functionality, in terms of bending, compressibility, water-blocking ability, fiber optic stranding pattern, etc in longitudinal and/or width directions. For instance, compressible layer 14a can have discontinuous shapes such as alternating ridges and channels, perforations and openings, etc., depending on the intended application. It is also possible to have multiple compressible layers 14a and/or multiple water swellable components 14c. In such designs, the multiple components may have like or different properties. For example, if two compressible layers 14a were used, the different layers could have different compressibility (i.e., spring constants) for tailoring the cushioning; if two water-swellable components 14c were used, the different components could have different absorption rates or differing water-swellable effectiveness for differing liquids such as ionic and non-ionic liquids. Additionally, core 15 could include one or more dry inserts 14 generally disposed about the optical waveguide 12. Therefore, it should be understood that the concepts of the present invention may be used in a variety of structures shown and described herein, within the scope of the present disclosure.

To quantify the stretching-inhibiting feature of dry insert 14, according to one measure, the modulus of elasticity of the at least one reinforcing element 14b is greater than that of compressible layer 14a. For instance, the modulus of elasticity of the at least one reinforcing element 14b is about 2 times or more than the modulus of elasticity of the compressible layer. More preferably, the modulus of elasticity of the at least one reinforcing element 14b is about 2 times or more than the modulus of elasticity of the compressible layer. Illustratively, if the compressible layer had a modulus of elasticity of about 10 pascals then the at least one reinforcing element has a modulus of elasticity of about 20 pascals or more.

According to another measure of resistance to stretching, dry insert 14 is configured so that, when under a tensile load in longitudinal direction D, dry insert 14 stretches less than a predetermined amount. Illustratively, under a tensile load of about 10 Newtons the strain of dry insert should be less than about 2%, and preferably less than about 1%. A tensile loading of about 10 Newtons approximates the expected tensile load experienced by dry insert 14 during manufacturing. In particular, such tensile load level may be present in an S-Z stranded assembly, where assembly line back tension may be higher than in a continuously twisted assembly line, in part possibly due to one or both of higher line speed and/or the switchbacks inherent in an S-Z stranded configuration. Of course, dry inserts of the present invention may be used with any suitable assembly or cable construction whether stranded or not.

Dry insert 14 also has a predetermined ultimate tensile strength to inhibit breakage during manufacture. Generally speaking, the ultimate tensile strength of the dry insert 14 is preferably about 20 Newtons per centimeter width W of dry insert 14 or greater, more preferably about 30 Newtons per centimeter width W of dry insert 14 or greater. Additionally, other components may add tensile strength to dry insert 14 such as the optional water-swellable component. In further advantageous embodiments, the resistance to longitudinal stretching can be increased by using a water-swellable component having a strain in the longitudinal direction at 10 Newtons that is less than the strain in the longitudinal direction at 10 Newtons in the at least one reinforcing element. Of course, the relative dimensions and properties of the various elements of optical waveguide assembly 10 may be modified, depending on the application for the same.

For instance, optical waveguides 12 are a plurality of single-mode optical fibers disposed in ribbons 13, but other suitable types of optical waveguides may be used with the concepts of the invention. Illustratively, optical waveguide 12 can be multi-mode, pure-mode, erbium doped, polarization-maintaining fiber, plastic, other suitable types of light waveguides, and/or combinations thereof. Additionally, other types or configurations of optical waveguides can be used such as loose, tight-buffered or in bundles. Optical waveguide 12 can also include an identifying means such as ink or other suitable indicia for identification. Suitable optical fibers are commercially available from Corning Incorporated of Corning, N.Y.

FIG. 6 is a cross-sectional view of a second embodiment of an optical waveguide assembly 10′, which is similar to optical waveguide assembly 10. As shown, core 15′ is formed by the at least one optical waveguide 12 and dry insert 14. In this embodiment, optical waveguide 12 is a loose optical fiber, instead of being disposed in a ribbon like optical waveguide assembly 10 of FIG. 1. Therefore, it should be understood that various types, number, and configurations of optical fibers may be employed within the scope of the invention. Additionally, one or more optical waveguide assemblies can form a portion of a fiber optic cable.

FIG. 7 is a cross-sectional view of a fiber optic cable 70 according to certain aspects of the invention. Fiber optic cable includes optical waveguide assembly 10 disposed within a sheath system 20 thereby forming fiber optic cable 70. As depicted therein, sheath system 20 includes one or more strength members 19a and a cable jacket 19b. Sheath system 20 may also optionally include a water-swellable tape 19c between optical waveguide assembly 10 and cable jacket 19b, if desired, along with optional binding threads 19d for holding the water-swellable tape 19c in place. It should be understood that fiber optic cable 70 is one of many assemblies that could be manufactured using the concepts of the present invention.

For example, FIG. 8 depicts a cross-sectional view of another fiber optic cable 80 that is a tubeless configuration. As shown, the at least one optical waveguide 12 is a portion of a ribbon that is part of a ribbon stack (not numbered) as in FIG. 1, disposed within a cavity of a cable jacket 84. Dry insert 14 is disposed within the cavity and generally adjacent to the ribbons for providing cushioning, coupling, etc. As shown, two dry inserts 14 are provided at the top and bottom of the ribbon stack to form a core (not numbered). In other words, the components form a dry insert/ribbon sandwich with the first dry insert disposed on a first planar side of the ribbon (or ribbon stack) and the second dry insert being disposed on a the second major side of the ribbon (or ribbon stack) within the generally rectangular cavity. Stated another way, planar surface(s) of the ribbon generally faces the planar surface(s) of the dry insert and the planar surface of the dry insert is also generally aligned with the major dimension of the cavity so that all of the major planar surfaces of the components are generally aligned within the generally rectangular cavity as depicted in FIG. 8. Two strength members 82 are provided on either side of the cavity and disposed within cable jacket 84. Of course, a different number, and/or configuration of dry inserts 14 may be used to form the core. Of course, a different number, and/or configuration of dry inserts 14 may be used to form the core. Likewise, any of the types of dry insert discussed above may be employed for dry insert 14 in fiber optic cable 80. For instance, dry insert 14 includes at least a compressible layer 14a and at least one reinforcing element 14b, but could also include water-swellable components, if desired. Fiber optic cable 80 could also include binder threads, rip cords, armor, or other suitable cable components, if desired. Thus, fiber optic cables 70 and 80 are exemplary optical waveguide assemblies according to the present invention and various modifications and alterations are possible to the disclosed cables.

FIG. 9 schematically illustrates an exemplary manufacturing line 40 for making optical waveguide assembly 10 according to the present invention. Manufacturing line 40 includes at least one optical waveguide payoff reel 41, a dry insert payoff reel 42, an optional binding station 44, a cross-head extruder 45, a water trough 46, and a take-up reel 49. Additionally, optical waveguide assembly 10 may be manufactured with a sheath system therearound, thereby forming a fiber optic cable similar to fiber optic cable 70 as illustrated in FIG. 7. The sheath system can include strength members 19a and a cable jacket (not numbered), which can be manufactured on the same line as tube assembly 10 or on a second manufacturing line. The exemplary manufacturing process includes paying-off at least one optical waveguide 12 and dry insert 14 from respective reels 41 and 42. Only one payoff reel for each of optical waveguide 12 and dry insert 14 is shown for clarity; however, the manufacturing line can include any suitable number of payoff reels to manufacture tube assemblies and cables according to the present invention. Next, optional binding station 44 wraps one or more binding threads around dry insert 14, thereby forming core 15. Thereafter, core 15 is feed into cross-head extruder 45 where the tube 18 is extruded about core 15, thereby forming optical waveguide assembly 10. Tube 18 is then quenched in water trough 46 and then tube assembly 10 is wound onto take-up reel 49. As depicted inside the box, if one manufacturing line is set-up to make a fiber optic cable like fiber optic cable 70, then one or more strength members 19a are paid-off individual reels 47 and positioned adjacent to optical waveguide assembly 10, and the cable jacket is extruded about strength members 19a and optical waveguide assembly 10 using cross-head extruder 48, thereby forming the fiber optic cable. Thereafter, the fiber optic cable 50 passes into a second water trough 46 for cooling the cable jacket before being wound-up on take-up reel 49. Additionally, other cables and/or manufacturing lines according to the concepts of the present invention are possible. For instance, cables and/or manufacturing lines may include a water-swellable tape and/or an armor between optical waveguide assembly 10 and strength members 19a; however, the use of other suitable cable components or locations are possible.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A dry insert suitable for use in an optical waveguide assembly, the dry insert comprising:
a compressible layer, the compressible layer having a modulus of elasticity in a longitudinal direction of the dry insert; and
at least one reinforcing element, the at least one reinforcing element being attached to the compressible layer and having a modulus of elasticity in the longitudinal direction of the dry insert, wherein the modulus of elasticity of the at least one reinforcing element is greater than the modulus of elasticity of the compressible layer for inhibiting a longitudinal stretching of the dry insert under a tensile load, wherein the dry insert has a strain of about 1 percent or less along the longitudinal direction when a tensile load of about 10 Newtons is applied in the longitudinal direction.

2. The dry insert of claim 1, wherein a portion of the at least one reinforcing element is disposed within the compressible layer.

3. The dry insert of claim 1, wherein the at least one reinforcing element is disposed along an edge portion of the compressible layer.

4. The dry insert of claim 1, wherein the compressible layer is a foam tape.

5. The dry insert of claim 4, wherein the at least one reinforcing element includes one of a tape backing layer or at least one tensile yarn.

6. The dry insert of claim 1, further having a water-swellable characteristic.

7. The dry insert of claim 6, wherein the water-swellable component contacts a portion of the compressible layer.

8. The dry insert of claim 1, further including a water-swellable component, wherein the at least one reinforcing element is disposed between the water-swellable component and the compressible layer.

9. The dry insert of claim 1, wherein the dry insert is a portion of a fiber optic cable.

10. A dry insert suitable for use in an optical waveguide assembly, the dry insert comprising:
a compressible layer, the compressible layer having a modulus of elasticity in a longitudinal direction of the dry insert; and
at least one reinforcing element, the at least one reinforcing element attached to the compressible layer and having a modulus of elasticity in the longitudinal direction of the dry insert, wherein the modulus of elasticity of the at least one reinforcing element at least about 2 times greater than the modulus of elasticity of the compressible layer for inhibiting a longitudinal stretching of the dry insert under a tensile load.

11. The dry insert of claim 10, the dry insert having a strain of about 1 percent or less along the longitudinal direction when a tensile load of about 10 Newtons is applied along the longitudinal direction.

12. The dry insert of claim 10, wherein the at least one reinforcing element contacts a portion of the compressible layer.

13. The dry insert of claim 10, wherein the at least one reinforcing element includes one of a tape backing layer or at least one tensile yarn.

14. The dry insert of claim 10, further including a water-swellable component.

15. The dry insert of claim 10, wherein the water-swellable component has a tensile strength in the longitudinal direction that is greater than a tensile strength of the at least one reinforcing element.

16. The dry insert of claim 10, wherein the at least one reinforcing element is disposed between the water-swellable component and the compressible layer.

17. The dry insert of claim 10, wherein the dry insert is a portion of a fiber optic cable.

18. An optical waveguide assembly comprising:
at least one optical waveguide;
at least one dry insert, the dry insert including a compressible layer and at least one reinforcing element that are attached together, the compressible layer having a modulus of elasticity in a longitudinal direction of the at least one dry insert and the reinforcing element having a modulus of elasticity in the longitudinal direction of the at least one dry insert, wherein the modulus of elasticity of the at least one reinforcing element is greater than the modulus of elasticity of the compressible layer for inhibiting a longitudinal stretching of the dry insert under a tensile load, wherein the at least one optical waveguide and the at least one dry insert form a core; and
a tube, the tube disposed about the core.

19. The optical waveguide assembly of claim 18, the at least one dry insert having a strain of about 1 percent or less along the longitudinal direction when a tensile load of about 10 Newtons is applied along the longitudinal direction.

20. The optical waveguide assembly of claim 18, wherein the at least one reinforcing element contacts a portion of the compressible layer.

21. The optical waveguide assembly of claim 18, wherein the at least one reinforcing element includes one of a tape backing layer or at least one tensile yarn.

22. The optical waveguide assembly of claim 18, the at least one dry insert further includes a water-swellable component.

23. The optical waveguide assembly of claim 22, wherein the water-swellable component contacts a portion of the compressible layer.

24. The optical waveguide assembly of claim 22, wherein the water-swellable component has a strain in the longitudinal direction at 10 Newtons that is less than the at least one reinforcing element strain in the longitudinal direction at 10 Newtons.

25. The optical waveguide assembly of claim 18, further including a water-swellable component, wherein that at least one reinforcing element is disposed between the water-swellable component and the compressible layer.

26. The optical waveguide assembly of claim 18, wherein the at least one optical waveguide is a portion of a fiber optic ribbon.

27. The optical waveguide assembly of claim 18, wherein the compressible layer is a foam tape.

28. The optical waveguide assembly of claim 18, further including at least one strength member for carrying the tensile load applied to the optical waveguide assembly.

29. The optical waveguide assembly of claim 18, wherein the tube is a cable jacket.
